(19) United States
(12) Patent Application Publication
(10) Pub. No.: US 2005/0135034 A1
(43) Pub. Date: Jun. 23, 2005

(54) Resettable circuit breaker

(75) Inventors: Kris W. Johnson, Washington, IL (US); Arthur Wild, Chillicothe, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar, Inc.

(21) Appl. No.: 10/739,226

(22) Filed: Dec. 19, 2003

(51) Int. Cl. H02H 3/08

(52) U.S. Cl. 361/93.1

(57) ABSTRACT

A resettable circuit breaker includes a current monitoring and interrupting circuit including an electrically conductive line carrying a current. A sensor outputs a voltage level indicative of the magnitude of the current. A comparator compares the voltage level to a reference potential and generates a circuit indicator signal. A logic-based current interrupter controls the current in the line in response to the circuit indicator signal.

### TECHNICAL FIELD

This invention relates generally to a circuit breaker and, more particularly, to a resettable circuit breaker.

### BACKGROUND

Electrical circuitry, especially circuitry that carries significant levels of current (e.g., power electronics), may be susceptible to damage caused by current levels that exceed rated or expected values for the circuitry. Such overcurrent conditions may be caused by unexpected power surges, short circuits, large current loads, and other types of events. In the absence of some form of overcurrent protection, electrical circuit components may be irreversibly damaged by high currents, which may result in a partial or complete circuit failure.

Various devices and circuits exist for protecting electrical circuitry from overcurrent conditions. For example, a fuse is a passive device that can physically break in response to a current level that exceeds the rated current for the fuse. While fuses may be highly effective in protecting electrical components, they have several shortcomings. Specifically, fuses are generally not reuseable. Once a fuse has broken, it must be replaced before current can again flow in the circuit protected by the fuse. This can lead to costly downtime for an electrical component or machine. Further, certain fuses, especially those for high current/high voltage applications, may be expensive.

Circuit breaking devices, other than fuses, may also be used to protect electrical circuitry from overcurrent conditions. Many of these devices include some type of mechanical switch that opens in the presence of an overcurrent. For example, U.S. Pat. No. 4,425,596 (“the '596 patent”) to Satou describes a circuit breaker that includes a current sensor and a mechanical switching device. When the current sensor detects a current overload, a control circuit energizes a trip coil that opens electrical contacts in a power line. While the circuit breaker of the '596 patent may be reset, unlike a fuse, the circuit breaker is nonetheless problematic. For example, the circuit breaker of the '596 patent depends on complicated mechanical switches with moving parts. Further, the mechanical switches of the '596 patent may be unsuitable for high voltage DC potentials that can cause arcing across open mechanical switches.

The present invention is directed to overcoming one or more of the problems or disadvantages existing in the circuit breaking methods and apparatus of the prior art.

### SUMMARY OF THE INVENTION

One aspect of the present invention includes a current monitoring and interrupting circuit including an electrically conductive line carrying a current. A sensor outputs a voltage level indicative of the magnitude of the current. A comparator compares the voltage level to a reference potential and generates a circuit indicator signal. A logic-based current interrupter controls the current in the line in response to the circuit indicator signal.

A second aspect of the present invention includes a method of monitoring and interrupting current flowing in an electrically conductive line. The method includes sensing the current flowing in the electrically conductive line and generating a voltage level indicative of the magnitude of the current. The voltage level is compared to a reference voltage, and a circuit indicator signal is generated. A logic-based device may be used to cause an interruption of the current flowing in the electrically conductive line if the circuit indicator signal is indicative of a condition where the voltage level is higher than the reference voltage.

### BRIEF DESCRIPTION OF THE DRAWINGS

FIG. 1 is a block-level schematic representation of a current monitoring and interrupting circuit in accordance with an exemplary embodiment of the invention.

### DETAILED DESCRIPTION

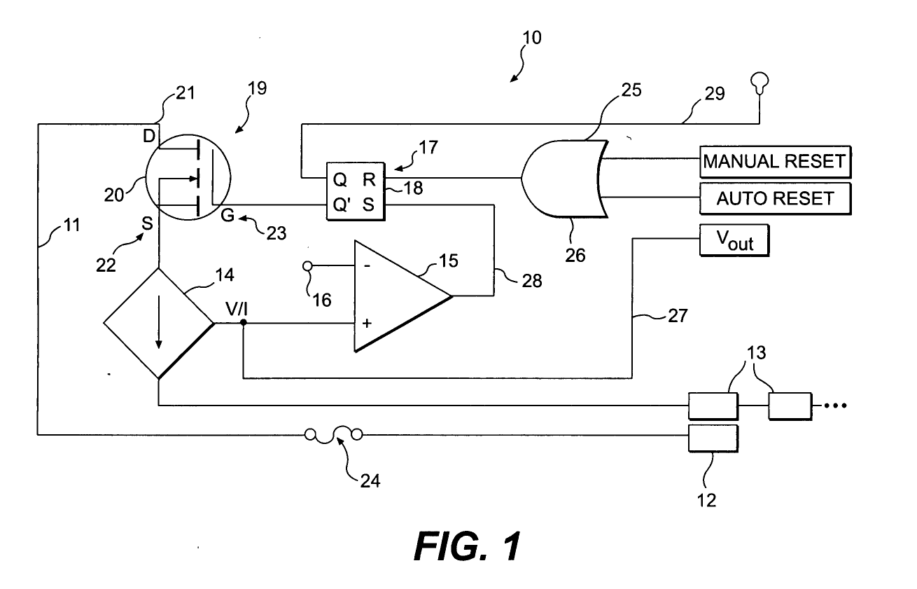

Circuit breaker 10, as represented by FIG. 1, can monitor the current flowing in an electrically conductive line 11 and can selectively interrupt the flow of current in line 11. While electrically conductive line 11 may be any conductor of electricity in any application, in one embodiment, electrically conductive line 11 may be part of a vehicular electrical system. For example, conductive line 11 may be connected to an accessory bus 12 of a vehicle and may supply current to one or more current loads 13, which may be various electrical components including, for example, air conditioning and/or heating units, lights, personal electronics devices, appliances, and any other type of electrically driven components.

Circuit breaker 10 may be useful for controlling the flow of direct currents (DC) or alternating currents (AC) having varying magnitude. For example, circuit breaker 10 may be used to interrupt the flow of currents ranging from just a few milliamps up to several hundred amps or more. Likewise, circuit breaker 10 may be used with a wide range of DC or AC voltage levels. In one embodiment, conductive line 11 may be connected to a low voltage level (e.g., a 12 volt battery). In other embodiments, however, conductive line 11 may be connected to an electrical bus energized to higher voltage levels. For example, conductive line 11 may include a voltage potential of at least 60 VDC. Further, conductive line 11 may include a voltage potential of at least 200 VDC. Further still, conductive line 11 may include a voltage potential of at least 300 VDC.

Circuit breaker 10 can actively monitor the current flowing in conductive line 11. For example, a current sensor 14 may be included as a component of circuit breaker 10. In one embodiment, current sensor 14 may provide a voltage output indicative of the magnitude of the current flowing in conductive line 11. For example, current sensor 14 may include a Hall effect device that generates a voltage level as a response to magnetic flux caused by the current flowing in conductive line 11.

Circuit breaker 10 may also include a voltage comparator 15 that aids in determining whether the current flowing in conductive line 11 exceeds a desired level. In one embodiment, comparator 15 may receive a first voltage level and a second voltage level and output a value indicative of whether the second voltage level is greater than the first voltage level. For example, the first voltage signal may correspond to a reference voltage 16, and the second voltage level may be supplied by sensor 14. Comparator 15 may provide a circuit indicator signal in the form of a digital output (e.g., a voltage output having two states; low and high). In one embodiment, comparator 15 may output a digital-high signal when the voltage level supplied by sensor 14 exceeds reference voltage 16. When the voltage from sensor 14 does not exceed reference voltage 16, however, comparator 15 may output a digital-low signal.

Reference voltage level 16 may be generated in a number of ways. For example, reference voltage 16 may be generated by a dedicated circuit that may include a power source (e.g., a battery) and one or more components connected to the power source for adjusting a voltage level provided by the power source. The adjusted voltage level may be used as reference voltage 16. Alternatively, reference voltage 16 may be supplied from a controller such as, for example, an electronic control module of a vehicle.

The level of reference voltage 16 may be set to correspond to a threshold current (e.g., the current level at which circuit breaker 10 will interrupt the current) on conductive line 11. The threshold current may be determined based on factors such as electrical component current ratings, the current carrying capacity of conductive line 11, and others. Once the threshold current has been established, the level of reference voltage 16 may be determined by taking into account the current-to-voltage measurement characteristics of sensor 14.

Circuit breaker 10 may also include a current interrupter 17 that controls the current in conductive line 11 in response to the circuit indicator signal provided by comparator 15. While current interrupter may include a wide variety of devices, in one exemplary embodiment, current interrupter may include a logic-based boolean device such as, for example, a flip flop 18. In this embodiment, flip flop 18 may be arranged such that a digital-low signal from comparator 15 results in a state where the current in conductive line 11 flows uninterrupted. A digital-high circuit indicator signal (i.e., indicating a breach of the threshold current) from comparator 15, however, results in an interruption of the current flow in conductive line 11.

In one exemplary embodiment, current interrupter 17 may control the flow of current in conductive line 11 by controlling a current switch 19 connected to line 11. For example, when the current in conductive line 11 is maintained below the threshold current level, comparator 15 maintains a digital-low signal on the S input of flip flop 18. As a result, and when the reset input R of flip flop is also in a digital-low state, the Q′ output of flip flop 18 is maintained in a digital-high state. Conversely, when comparator 15 provides a digital-high signal to the S input of flip flop 18, the Q′ output of flip flop 18 “flips” to a digital-low state. The Q′ output of flip flop 18 may be used to control current switch 19.

Current switch 19 may include any device or devices capable of selectively controlling the flow of current in conductive line 11. In one embodiment, current switch 19 may include a transistor-based device such as, for example, a MOSFET 20. In embodiments experiencing high voltage and current levels, MOSFET 20 may comprise a power MOSFET. MOSFET 20 includes a drain 21, a source 22, and a gate 23. MOSFET 20 may be disposed in conductive line 11 such that one portion of conductive line 11 entering MOSFET 20, for example, may be connected to a terminal at drain 21, and a portion of conductive line 11 exiting MOSFET 20, for example, may be connected to a terminal at source 22. In response to a non-zero voltage at gate 23 (e.g., a digital-high signal), MOSFET 20 acts as a short circuit and allows current to flow virtually unimpeded in conductive line 11. In response to a digital-low signal at gate 23, however, MOSFET 20 acts as an open circuit, and no current is allowed to flow on conductive line 11.

Thus, in circuit breaker 10, as illustrated in FIG. 1, MOSFET 20 will allow current to flow in conductive line 11 when the current is maintained below a threshold current level (i.e., the voltage from sensor 14 does not exceed reference voltage 16, comparator 15 outputs a digital-low signal, and the Q′ output of flip flop 18 maintains a digital-high signal at gate 23). MOSFET 20, however, will prevent the flow of current in conductive line 11 when the current exceeds the threshold current level (i.e., the voltage from sensor 14 exceeds reference voltage 16, comparator 15 outputs a digital-high signal, and the Q′ output of flip flop 18 provides a digital-low signal to gate 23).

It should be noted that other devices may be substituted for MOSFET 20 depending on a particular application. For example, in situations where circuit breaker 10 is designed to impede the flow of alternating current, MOSFET 20 may be substituted with a device such as a gate turn-off (GTO) thyristor, a triac, or another similar device for controlling current that flows in both forward and reverse directions.

Circuit breaker 10 may optionally include a fuse 24. Because circuit breaker 10 actively monitors the current flowing in conductive line 11 and halts the flow of current when an overcurrent condition is detected, a fuse is not a necessary component of circuit breaker 10. Nevertheless, fuse 24 may be used in conjunction with circuit breaker 10 to break the circuit in the event of an overcurrent condition and a failure of circuit breaker 10.

Circuit breaker 10 may include a reset circuit 25. After an overcurrent condition resulting in a digital-low signal at the Q′ output of flip flop 18, a digital-high reset signal may be provided to the reset input R of flip flop 18. In response to this reset signal, the Q′ output of flip flop 18 “flips” back to a digital-high state. If the overcurrent condition no longer exists, then the Q′ output of flip flop 18 is maintained at a digital-high state after the reset, and current is allowed to flow in conductive line 11. Reset circuit may include various components such as, for example, an OR gate 26. OR gate 26 forwards a reset signal to flip flop 18 when either a manual reset signal or an auto reset signal is generated. The manual reset signal may represent input from a user, such as, for example, a vehicle operator. The auto reset signal may be generated automatically by a controller or processing device such as the electronic control unit (ECU) of a vehicle. For example, the ECU may monitor one or more of the analog voltage from sensor 14 on line 27, the signal from comparator 15 on line 28, an indicator signal on line 29, or any other appropriate signal. From these signals, the ECU may determine whether an overcurrent situation exists and whether it would be appropriate to auto-reset circuit breaker 10.

Circuit breaker 10 may include an overcurrent indicator function that can relay information regarding whether an overcurrent condition exists and whether current is flowing in conductive line 11. For example, as described above, an overcurrent condition on conductive line 11 causes a digital-low signal on the Q′ output of flip flop 18. The same overcurrent condition also causes a digital-high signal on the Q output of flip flop 18, which represents the inverse of the Q′ output. The digital-high signal on the Q output may be used to power a warning light or other type of indicator capable of conveying information regarding the presence of an overcurrent condition. Alternatively, the Q output of flip flop 18 may be routed to a controller such as the ECU of a vehicle. The controller may automatically perform any appropriate action in response to the overcurrent condition. For example, the controller may provide a warning message on a display or may disable one or more components that have either caused the overcurrent condition or are affected by the overcurrent condition.

### Industrial Applicability

Circuit breaker 10 may be used to minimize or prevent overcurrents in nearly any type of electrical circuit. Further, circuit breaker 10 may be used to control both alternating and direct currents. Because the disclosed circuit breaker may be implemented with no moving parts or mechanical switching devices, the circuit breaker may be especially useful for controlling currents flowing in response to DC voltage potentials. For example, unlike prior art circuit breakers, circuit breaker 10 may be less susceptible to arcing even in the presence of high voltage DC potentials (e.g., up to several hundred volts DC or more). Thus, circuit breaker 10 may be used to protect circuitry associated with any source of DC voltage potentials including, for example, electrical accessory buses for a vehicle. In one application, circuit breaker 10 may be used to monitor and control currents associated with a vehicle accessory bus energized to 340 VDC.

By actively monitoring the current flowing in a conductive line and preventing overcurrents, circuit breaker 10 may provide the current-protection functionality of fuses. Unlike fuses, however, circuit breaker 10 is resettable.

Further, control of the logic-based components of circuit breaker 10 (e.g., resetting, switching, etc.) may be accomplished using a controller. Thus, circuit breaker 10 may be well-suited for applications, such as vehicles, which may include a controller (e.g., an ECU) that can be adapted and used to drive circuit breaker 10.

Circuit breaker 10 may be implemented with readily available components. Thus, circuit breaker 10 may be fabricated inexpensively.

It will be apparent to those skilled in the art that various modifications and variations can be made in the disclosed circuit breaker without departing from the scope of the disclosure. Additionally, other embodiments of the circuit breaker will be apparent to those skilled in the art from consideration of the specification. It is intended that the specification and examples be considered as exemplary only, with a true scope of the disclosure being indicated by the following claims and their equivalents.

1. A current monitoring and interrupting circuit, comprising:
an electrically conductive line carrying a current;
a sensor that outputs a voltage level indicative of a magnitude of the current;
a comparator that compares the voltage level to a reference potential and generates a circuit indicator signal; and
a logic-based current interrupter that controls the current in the line in response to the circuit indicator signal.

2. The circuit of claim 1, further including a current switch disposed in the electrically conductive line and connected to the logic-based interrupter.

3. The circuit of claim 2, wherein the current switch includes a MOSFET.

4. The circuit of claim 1, further including a fuse disposed in the electrically conductive line.

5. The circuit of claim 1, wherein the electrically conductive line is part of an electrical bus energized to at least 60 VDC.

6. The circuit of claim 1, wherein the electrically conductive line is part of an electrical bus energized to at least 200 VDC.

7. The circuit of claim 1, wherein the electrically conductive line is part of an electrical bus energized to at least 300 VDC.

8. The circuit of claim 1, wherein the electrically conductive line is part of a vehicular electrical bus.

9. The circuit of claim 1, wherein the sensor includes a Hall effect device.

10. The circuit of claim 1, wherein the logic-based current interrupter includes a boolean logic device.

11. The circuit of claim 10, wherein the boolean logic device includes a flip flop.

12. The circuit of claim 1, further including a reset circuit.

13. The circuit of claim 1, further including an indicator that signals whether the current is flowing in the electrically conductive line.

14. A method of monitoring and interrupting current flowing in an electrically conductive line, comprising:
sensing the current flowing in the electrically conductive line;
generating a voltage level indicative of a magnitude of the current;
comparing the voltage level to a reference voltage and generating a circuit indicator signal; and
using a logic-based device to cause an interruption of the current flowing in the electrically conductive line if the circuit indicator signal is indicative of a condition where the voltage level is higher than the reference voltage.

15. The method of claim 14, wherein the logic-based device includes a flip flop that controls a current switch.

16. The method of claim 15, wherein the current switch includes a MOSFET.

17. The method of claim 14, further including resetting the logic-based device to restore the current flowing in the electrically conductive line.

18. The method of claim 17, wherein the step of resetting is performed automatically.

19. The method of claim 14, further including generating an indicator signal that conveys whether the current is flowing in the electrically conductive line.

20. The method of claim 14, wherein the current flowing in the electrically conductive line is a direct current (DC).

21. A circuit breaker for interrupting a flow of current in an electrically conductive line, comprising:
a sensor that outputs a voltage level indicative of a magnitude of the current;
a comparator that compares the voltage level to a reference potential and generates a circuit indicator signal;
a logic device that receives the circuit indicator signal and generates a current interrupt signal when the circuit indicator signal corresponds to a condition where the voltage level is greater than the reference potential; and
a current switch that selectively prevents the flow of current in the electrically conductive line in response to the current interrupt signal.

22. The circuit breaker of claim 21, wherein the sensor includes a Hall effect current transducer.

23. The circuit breaker of claim 21, wherein the logic device includes a flip flop.

24. The circuit breaker of claim 21, wherein the current switch includes a MOSFET.
